(19) United States
(12) Patent Application Publication
(10) Pub. No.: US 2007/0256443 A1
(43) Pub. Date: Nov. 8, 2007

(54) METHOD OF MAINTAINING THE STABILITY AND QUALITY OF FROZEN DESSERTS DURING STORAGE AND TRANSPORTATION

(76) Inventors: James T.C. Yuan, Nasperville, IL (US); Amit Vohra, Chicago, IL (US)

Correspondence Address: AIR LIQUIDE;Intellectual Property, 2700 POST OAK BOULEVARD, SUITE 1800, HOUSTON, TX, 77056, US

(21) Appl. No.: 11/533,640

(22) Filed: Sep. 20, 2006

Related U.S. Application Data
(60) Provisional application No. 60/796,919, filed on May 2, 2006.

(51) Int. Cl. F25D 3/08; F25D 17/02; F25D 3/12; F17C 13/00

(52) U.S. Cl. 62/388; 62/371; 62/373; 62/457.9

(57) ABSTRACT

Processes for maintaining the stability and quality of frozen desserts during storage and transportation including an improvement. This improvement process involves introducing a liquid or solid cryogen into an insulated storage compartment, and allowing the cryogen to evaporate, or sublimate, thereby cooling the storage compartment, while simultaneously allowing for the control of the pressure within this compartment.

### CROSS REFERENCE TO RELATED APPLICATIONS

This application claims the benefit of U.S. Provisional Application No. 60/796,919, filed May 2, 2006, the entire contents of which are incorporated herein by reference.

### BACKGROUND

Ice cream is, essentially, a foam consisting of air bubbles dispersed in a mixture of fat, water and ice crystals. The air fraction is typically around 50% by volume, and this is crucial for the product to have the consistency and texture desired by customers.

The term “overrun”, is used to indicate how much air a particular ice cream contains. It is basically the ratio of the volume of the ice cream, less the volume of the liquid ice cream mix, divided by the volume of the liquid ice cream mix. So, if 50% of the volume of the ice cream is air, one would say that it had a 100% overrun.

U.S. federal standards limit the amount of air by specifying that a liter of ice cream must weigh at least 0.54 kilograms. U.S. ice creams typically do not contain over 100% overrun. Regular, to premium ice cream, generally has 80%-100% overrun, and super premium ice cream often has 20%-50% overrun.

While recognizing that this large percentage of air must be incorporated into the final ice cream product, the main aim of ice cream manufacturing is to incorporate the smallest sizes and largest numbers of air bubbles, ice crystals, and fat globules into an aqueous phase.

However, these colloidal components are inherently unstable, which leads to problem with maintaining the stability of ice cream structure subsequent to manufacture.

In recent times, the stability of air cells within the ice cream product during storage and transportation has been studied extensively by researchers. Sofjan and Hartel investigated the effect of overrun on air cell stability, and demonstrated that higher overrun led to slightly more stable air cells during storage. On the other hand, Chang and Hartel, as explained in their various publications, have studied the effects of operating conditions and formulation, as well as the type, level of emulsifier, and stabilizer on the development of air cells during storage and hardening of dairy foams.

Commercially, different stabilizers, such as alginates, guar, locus bean, xanthan, carrageenan, and chemically modified cellulose gums (carboxymethylcellulose, CMC) are being used in combination. It has been found that this provides a more stable emulsion and helps prevent air bubble collapse/shrinkage during storage or transportation. Emulsifiers, such as a blend of propylene glycol monostearate, sorbitan tristearate, and unsaturated monoglycerides, EDTA, proteose peptone whey fraction, a mix of mono and diglycerides (MDG), alone, or in combination with polysorbates, as well as polyglycerols, and lecithin (or egg yolk), have also been used. These tend to establish and maintain a more stable structure around the air-cell walls. The incorporation of surfactants, such as Tween 60, has been shown to be effective in stabilizing air cells in ice creams.

However, despite these efforts, the problem of degradation of frozen desserts during the transportation, or storage due to pressure variations, owing to altitude changes still exists. Since trapped air bubbles (cells) form a significant portion of the total product volume, change in volume of trapped air bubbles, due to pressure variations, may lead to lids popping and leakage when shipped to high altitudes. On the other hand, product shrinkage occurs when shipped to low altitudes.

While ice cream has been discussed in detail, related issues are also found in the transportation of other frozen desserts.

There is a need in the industry for a method to maintain and control the storage and transportation environment of frozen desserts.

### SUMMARY

The process in the present application is directed to a method that satisfies the need in society in general a method to maintain and control the storage and transportation environment of frozen desserts.

In one aspect of the process in the present application method of maintaining the stability and quality of frozen food products, during storage and transportation, is provided. This method uses a refrigeration chamber having an insulated storage compartment, and this refrigeration chamber has a pressure relief device. This method uses a cryogenic environmental control material, and this cryogenic environmental control material is in a non-gaseous phase. This method involves pressurizing the refrigeration chamber by the controlled release of the cryogenic environmental control material into the gas phase; and then controlling the pressure of the refrigeration chamber with the pressure relief device.

In one aspect of the process in the present a method of maintaining the stability and quality of frozen food products, during storage and transportation, is provided. This method uses a refrigeration chamber having an insulated storage compartment, and the refrigeration chamber has a pressure relief device. This method uses a cryogenic environmental control material, and the cryogenic environmental control material is in a non-gaseous phase. This method uses a refrigeration chamber by the controlled release of said cryogenic environmental control material into the gas phase. This method involves controlling the pressure of the refrigeration chamber with the pressure relief device, and controlling the temperature of the refrigeration chamber with a temperature control device.

### DESCRIPTION OF PREFERRED EMBODIMENTS

Illustrative embodiments are described below. While the process in the present application is susceptible to various modifications and alternative forms, specific embodiments thereof have been shown by way of example in the drawings and are herein described in detail. It should be understood, however, that the description herein of specific embodiments is not intended to limit the process in the present application to the particular forms disclosed, but on the contrary, the process in the present application is to cover all modifications, equivalents, and alternatives falling within the spirit and scope of the process in the present application as defined by the appended claims.

It will, of course, be appreciated that in the development of any such actual embodiment, numerous implementation-specific decisions must be made to achieve the developer's specific goals, such as compliance with system-related and business-related constraints, which will vary from one implementation to another. Moreover, it will be appreciated that such a development effort might be complex and time-consuming, but, would nevertheless, be a routine undertaking for those of ordinary skill in the art having the benefit of this disclosure.

The following definitions are solely to aid readers and are no narrower than the meaning of the terms as understood by a person skilled in the art.

The pressure within the refrigerated transportation vehicle must be regulated with precision, as is indicated by the following examples:
a) An common elevation change of 500 feet (e.g. from Chicago to Houston), will result in an atmospheric pressure difference of 0.25 psia (or 6.9 inches of water);
b) A modest elevation change of 1000 feet (e.g. from Birmingham to New Orleans), will result in an atmospheric pressure difference of 0.5 psia (or 13.8 inches of water);
c) An elevation change of 3000 feet (e.g. from Los Angeles to San Jose), will result in an atmospheric pressure difference of 1.5 psia (or 41.4 inches of water);
d) A significant elevation difference of 4000 feet (e.g. from El Paso to Houston), will result in an atmospheric pressure difference of 2.0 psia (or 55.2 inches of water); and
e) An even more significant, but entirely possible, elevation difference of 5000 feet (e.g. from Albuquerque to Phoenix), will only result in an atmospheric pressure difference of 2.5 psia (or 69.0 inches of water).

Therefore, a pressure variation of about 2.5 psia or less is the source of the problems with air cell growth and rupture that is leading to the shrinkage problems. It is clear that a pressure variation of 2.5 psia during shipping is far too extreme, and must be reduced significantly.

One embodiment of a proposed solution to this problem may be understood by way of an example.

Assume one has a standard well insulated, refrigerated truck that has a storage compartment which is 6 feet high, 7 feet wide, and 14 feet deep. These dimensions yield a total internal surface area of 448 square feet, and a total volume of 588 cubic feet.

If one assumes two inches of ordinary expanded polyurethane foam (K value of 0.15 Btu/sq ft/deg F/hour), this would yield a total heat transfer into the refrigerated area of about 33.6 Btu/deg F/hour. Thus, if the exterior ambient temperature is 75° F., and the desired interior temperature is −5° F., approximately 2520 Btu/hr of heat would need to be transferred out of the storage compartment (after thermal equilibrium is reached).

In one embodiment, liquid carbon dioxide that is evaporating may be used to pressurize and cool the compartment. Since liquid carbon dioxide that is being stored at 32° F., has a latent heat of vaporization of approximately 100 Btu/lb, this load is roughly equivalent to the cooling capacity of about 25 lb/hr of liquid carbon dioxide being evaporated, or about 600 pounds of liquid carbon dioxide being evaporated for every 24 hours of operation.

Since gaseous carbon dioxide has a specific gravity of 1.525 (at 32° F. and 1 atm), 600 pounds of gaseous carbon dioxide would have volume of about 5250 cubic feet. If a pressure relief valve is set at 10″ to 20″ of water over atmospheric pressure, and had a flow (at this pressure setting) of about 3.5 SCFM, equilibrium between the evaporation rate of the liquid carbon dioxide (with respect to the desired compartment temperature) and the pressure that is maintained within the compartment would be reached.

Such an embodiment would allow for the maintenance of the pressure within the insulated compartment, during the gradual ascents and descents that would be encountered during the transportation of the frozen desserts.

In another embodiment, solid carbon dioxide which is evaporating may be used to pressurize and cool the compartment. Since solid carbon dioxide has a surface temperature of −109.3° F., it has a latent heat of sublimation of 245.5 Btu/lb, this load is roughly equivalent to the cooling capacity of about 10 lb/hr of solid carbon dioxide being evaporated, or about 250 pounds of solid carbon dioxide evaporated for every 24 hours of operation.

Since gaseous carbon dioxide has a specific gravity of 1.525 (at 32° F. and 1 atm), 250 pounds of gaseous carbon dioxide would have volume of about 2200 cubic feet. If a pressure relief valve is set at 10″ to 20″ of water over atmospheric pressure, and had a flow (at this pressure setting) of about 1.5 SCFM, equilibrium between the evaporation rate of the liquid carbon dioxide (with respect to the desired compartment temperature) and the pressure that is maintained within the compartment would be reached.

Such an embodiment would allow for the maintenance of the pressure within the insulated compartment during the gradual ascents and descents that would be encountered during the transportation of the frozen desserts.

In another embodiment, we assume an exterior ambient temperature is 75° F., and the desired interior temperature is −5° F., however, we assume a standard commercial mechanical refrigeration system is installed in the delivery truck. If we assume that the mechanical refrigeration system brings the temperature in the storage compartment down to 0° F., approximately 170 Btu/hr of heat would need to be transferred out of the storage compartment (after thermal equilibrium is reached).

In this embodiment, either liquid carbon dioxide, or solid carbon dioxide, may be used to pressurize and cool the compartment. In this example, we will consider solid carbon dioxide, but the skilled artisan will readily see how liquid carbon dioxide would also work.

Since solid carbon dioxide has a surface temperature of −109.3° F., it has a latent heat of sublimation of 245.5 Btu/lb, this load is roughly equivalent to the cooling capacity of about 0.7 lb/hr of solid carbon dioxide being evaporated, or about 17 pounds of solid carbon dioxide evaporated for every 24 hours of operation.

Since gaseous carbon dioxide has a specific gravity of 1.525 (at 32° F. and 1 atm), 17 pounds of gaseous carbon dioxide would have volume of about 150 cubic feet. If a pressure relief valve is set at 10″ to 20″ of water over atmospheric pressure, and had a flow (at this pressure setting) of about 0.10 SCFM, equilibrium between the evaporation rate of the liquid carbon dioxide (with respect to the desired compartment temperature) and the pressure that is maintained within the compartment would be reached.

In the practical operation of such a system, the temperature control system for the mechanical refrigeration system may need to be altered to incorporate an offset to account for the additional cooling provided by the cryogenic gas system. If this offset is desired to be 5° F., as in the above examples, the mechanical refrigeration system may be adjusted to react to a −5° F. actual temperature, as if it were actually detecting 0° F. With such an adjusted system, the two refrigeration systems will not be compensating for each other.

Such an embodiment would allow for the maintenance of the pressure within the insulated compartment during the gradual ascents and descents that would be encountered during the transportation of the frozen desserts.

As carbon dioxide gas is heavier than air, this gas will collect near the floor of the storage compartment. It is therefore preferable that the above referenced pressure relief value be located as close to the floor of the storage compartment as is technically feasible, thereby avoiding any dangerous buildup of carbon dioxide vapors within the enclosed space. As a further safety precaution, multiple redundant systems may be installed.

These pressure relief valves may be a spring-operated regulator. The pressure relief valve may be a control valve which received a signal from a pressure sensing device. The pressure relief valve may simply be a manual valve that is opened to a predetermined amount, and left unattended.

In another embodiment, a heating means may be provided in order to allow control of the temperature within the storage compartment, should the pressure and refrigeration requirements reach a disequilibrium. Should the temperature of the storage compartment drop below a minimum desired temperature, this heating means would introduce heat into the compartment to raise the temperature. This heating means may be an electrical heating element or a slip stream from the combustion exhaust system of the transportation engine, or any other heating means known to the skilled artisan.

While carbon dioxide (in either liquid or solid form) was used in the above examples, the skilled artisan would recognize that this cryogenic environmental control material could be any material selected from the following group: liquid air, liquid nitrogen, liquid oxygen, liquid carbon dioxide, liquid nitrous oxide, liquid argon, liquid krypton, liquid xenon, liquid neon, or any mixtures thereof.

What is claimed is:

1. A method of maintaining the stability and quality of frozen food products during storage and transportation, comprising:
a) providing a refrigeration chamber having an insulated storage compartment, wherein said refrigeration chamber comprises a pressure relief device;
b) providing a cryogenic environmental control material, wherein said cryogenic environmental control material is in a non-gaseous phase;
c) pressurizing said refrigeration chamber by the controlled release of said cryogenic environmental control material into the gas phase; and
d) controlling the pressure of said refrigeration chamber with said pressure relief device.

2. The method of claim 1, wherein said cryogenic environmental control material is solid carbon dioxide.

3. The method of claim 1, wherein said cryogenic environmental control material is selected from the group consisting of:
a) liquid air;
b) liquid nitrogen;
c) liquid oxygen;
d) liquid carbon dioxide;
e) liquid nitrous oxide;
f) liquid argon;
g) liquid krypton;
h) liquid xenon;
i) liquid neon, or
j) any mixtures thereof.

4. The method of claim 1, wherein said pressure relief device is a spring-operated regulator.

5. The method of claim 1, wherein said pressure relief device is a control valve, wherein said control valve receives a signal from a pressure sensing device.

6. A method of maintaining the stability and quality of frozen food products during storage and transportation, comprising:
a) providing a refrigeration chamber having an insulated storage compartment, wherein said refrigeration chamber comprises a pressure relief device;
b) providing a cryogenic environmental control material, wherein said cryogenic environmental control material is in a non-gaseous phase;
c) pressurizing said refrigeration chamber by the controlled release of said cryogenic environmental control material into the gas phase;
d) controlling the pressure of said refrigeration chamber with said pressure relief device, and
e) controlling the temperature of said refrigeration chamber with a temperature control device.

7. The method of claim 6, wherein said cryogenic environmental control material is solid carbon dioxide.

8. The method of claim 6, wherein said cryogenic environmental control material is selected from the group consisting of:
a) liquid air;
b) liquid nitrogen;
c) liquid oxygen;
d) liquid carbon dioxide;
e) liquid nitrous oxide;
f) liquid argon;
g) liquid krypton;
h) liquid xenon;
i) liquid neon, or
j) any mixtures thereof.

9. The method of claim 6, wherein said pressure relief device is a spring-operated regulator.

10. The method of claim 6, wherein said pressure relief device is a control valve, wherein said control valve receives a signal from a pressure sensing device.

11. The method of claim 6, wherein said temperature control device comprises a temperature sensing device and a heating means for providing heat to said refrigeration chamber.

12. The method of claim 11, wherein said heating means comprises transferring heat from combustion exhaust system of the transportation engine.

13. The method of claim 11, wherein said heating means comprises an electrical heating element.
